(19) United States
(12) Patent Application Publication
(10) Pub. No.: US 2008/0081101 A1
(43) Pub. Date: Apr. 3, 2008

(54) Zero trans fat baking margarine with specific solid fat index range

(76) Inventor: Asim Syed, Omaha, NE (US)

Correspondence Address: SUITER SWANTZ PC LLO, 14301 FNB PARKWAY, SUITE 220, OMAHA, NE, 68154, US

(21) Appl. No.: 11/890,272

(22) Filed: Aug. 3, 2007

Related U.S. Application Data
(60) Provisional application No. 60/848,162, filed on Sep. 29, 2006.

(51) Int. Cl. A23D 7/00; A23C 9/00; A23D 7/02

(52) U.S. Cl. 426/585; 426/603

(57) ABSTRACT

The present invention is a margarine product. The margarine product includes an aqueous component, in a proportion of at the most 20% by weight of the margarine product, the aqueous component being emulsified in the fat. The margarine product further includes a first oil; and a second oil, wherein the first oil is interesterified and blended with the second oil to allow the margarine product to be suitable for baking, the margarine product having a solid fat index range of 28±5 @ 50° F., 20±5 @ 70° F., 13±4 @ 80° F., 4±2 @ 92° F., and 3 max @ 102° F. as defined by analytical method reference

### CROSS REFERENCE TO RELATED APPLICATIONS

The present application claims priority under 35 U.S.C. §119(e) to U.S. Provisional Patent Application No. 60/848,162, filed Sep. 29, 2006, which is herein incorporated by reference in its entirety.

### FIELD OF THE INVENTION

The present invention generally relates to the field of margarine, and more particularly to a trans fat free baking margarine with features that resemble the functional properties, taste, texture, and baking characteristics of a conventional margarine product having trans fat levels of between 30% and 50%.

### BACKGROUND OF THE INVENTION

Butter and conventional margarine products provide textures and flavors that are difficult to reproduce in baking. For example, a certain amount of hard fat is required in order to provide desired taste, texture, and baking properties. In order to increase the shelf-life of these products, as well as to reduce the amount of cholesterol contained in the products, margarines were developed. Margarines are a substitute for butter and utilize a mix of saturated and polyunsaturated vegetable oils in place of animal fat. Vegetable oils, which are usually acceptable in frying, muffins and cakes, are generally not suitable for cookies. Fruit purees, low fat or fat free sour cream, and yogurt can often be substituted for butter or margarine in cakes and muffins, but the outcome will be affected in some way, often leading to a denser product.

In order to achieve the taste, texture, and baking properties of butter, hydrogenation has been utilized to achieve firmness and melting point properties desirable for baking. By adding hydrogen atoms to the fat molecules in vegetable oils, the unsaturated fat molecules get saturated, raising the melting point of the fat and allowing it to remain solid at room temperature. Hydrogenation typically requires the presence of a metal catalyst and temperatures of about 500° F. (260° C.) at vacuum for this reaction to take place. Naturally occurring fatty acids contain double bonds of a particular configuration, referred to as “cis-” by biochemists. These cis- bonds cause the molecules to be “bent” so that two hydrogen atoms are on the same side of the double bond. Thus, the bonds between the molecules are weaker due to their irregular shape, which results in a lower melting point. Hydrogenation causes about half of the cis- bonds in the fat molecules to reconfigure to form trans- bonds. Fats with either trans- double bonds or no double bonds (“saturated”) are solid at room temperature.

Recently, it has become desirable to reduce the amount of trans fatty acids in food products, due to the ever increasing awareness of the negative health impacts of the trans fatty acids. Therefore, it would be advantageous to provide a trans fat free hard margarine with the functionality and baking characteristics of a conventional margarine.

### SUMMARY OF THE INVENTION

Accordingly, an embodiment of the present invention is directed to a margarine product including: aqueous component, in a proportion of at the most 20% by weight of the margarine product, the aqueous component being emulsified in the fat; a first oil; and a second oil, wherein the first oil is interesterified and blended with the second oil to allow the margarine product to be suitable for baking, the margarine product having a solid fat index range of 28±5 @ 50° F., 20±5 @ 70° F., 13±4 @ 80° F., 4±2 @ 92° F., and 3 max @ 102° F. as defined by analytical method reference AOCS Cd 10-57.

A further embodiment of the present invention is directed to a food product including: a nutritive ingredient, and a margarine product including an aqueous component, fat in a proportion of 20:80 by weight of the margarine product, a first oil, and a second oil, where the first oil is interesterified and blended with the second oil to provide a food product suitable for baking with a solid fat index of 28±5 @ 50° F., 20±5 @ 70° F., 13±4 @ 80° F., 4±2 @ 92° F., and 3 max @ 102° F. defined by analytical method reference AOCS Cd 10-57.

A further embodiment of the present invention is directed to a method for producing a margarine product including: providing an aqueous component; providing fat; providing an interesterified first oil; and combining the aqueous component, the fat, and the interesterified first oil with a second oil into an emulsion, where the combination produces the margarine product to be suitable for baking, the margarine product having a solid fat index of 28±5 @ 50° F., 20±5 @ 70° F., 13±4 @ 80° F., 4±2 @ 92° F., and 3 max @ 102° F. defined by analytical method reference AOCS Cd 10-57.

A further embodiment of the present invention is directed to a method for producing a food product including: providing a nutritive product; providing a margarine product having a emulsified first oil and a second oil, the margarine product having a solid fat index selected for baking, with a solid fat index of 28±5 @ 50° F., 20±5 @ 70° F., 13±4 @ 80° F., 4±2 @ 92° F., and 3 max @ 102° F. defined by analytical method reference AOCS Cd 10-57; combining the nutritive product and the margarine product; and processing the combined nutritive product and margarine product, where the processing includes at least one of baking, cooking, freezing, refrigeration, sautéing, broiling, or frying.

The significant advantages of the present invention include the functional baking characteristics of conventional hard margarines but with zero trans fat. The solid fat index measurements describe the percentage of a product that is solid at different, defined temperatures. The creation of this curve gives an understanding of properties and performance of oils over a range of temperatures.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustrating a method for producing a margarine product in accordance with an exemplary embodiment of the present invention;

FIG. 2 is a flow chart illustrating a method for producing a food product accordance with an additional exemplary embodiment of the present invention; and

FIG. 3 is a block diagram illustrating a system for implementing a method for producing a margarine product in accordance with an exemplary embodiment of the present invention.

### DETAILED DESCRIPTION OF THE INVENTION

In a present embodiment, the invention is directed to a margarine product. The margarine product includes an aqueous component ex. water, fat, a first oil, a second oil, milk solids, and salt. In a current embodiment, the water is no more than 20% by weight of the margarine product and the fat no less than 80% by weight of the margarine product. In a current embodiment, the aqueous component is emulsified in the fat.

The current embodiment is a trans fat free 80% hard margarine product with the functional properties suitable for baking. The functional properties of a margarine suitable for baking include machine-ability, taste, texture and baking characteristics of the dough when the margarine product is combined with the dough.

In the current embodiment, the first oil includes at least one of palm oil or palm kernel oil. The second oil is at least one of liquid soybean, canola, corn, cottonseed or sunflower oil. In the margarine product may include the milk solid in a proportion of between about 0.6% and about 1.0% by weight of the margarine product. salt in a proportion of between about 1 and about 4% by weight of the margarine product.

In a present embodiment, the first oil of the margarine product is interesterified and blended with the second oil. The first and second oil blend when combined with an appropriate amount of water, salt, and milk solid produces a margarine product with a solid fat index that is appropriate for baking. For example, the solid fat index range may be 28±5 @ 50° F., 20±5 @ 70° F., 13±4 @ 80° F., 4±2 @ 92° F., and 3 max @ 102° F., as defined by analytical method reference AOCS Cd 10-57.

In further embodiments, the margarine product of the present invention of the present invention has baking characteristics resembling those of conventional margarine products which have trans fat levels of between 30% and 50%. However, the margarine product of the present invention contains trans fat levels of less than 3% by weight of the margarine product. A further embodiment of the margarine product is saturated fat of approximately 45%, mono-unsaturated fat is approximately 15%, poly-unsaturated fat is approximately 17% by weight of the margarine product.

A further embodiment is directed to a food product. The food product contains a nutritive ingredient, and a margarine product as described above.

In the current embodiment, the food product can be any of cookies, cakes, pie crust, bread, bread products, and other products requiring the use of a trans fat free 80% hard margarine.

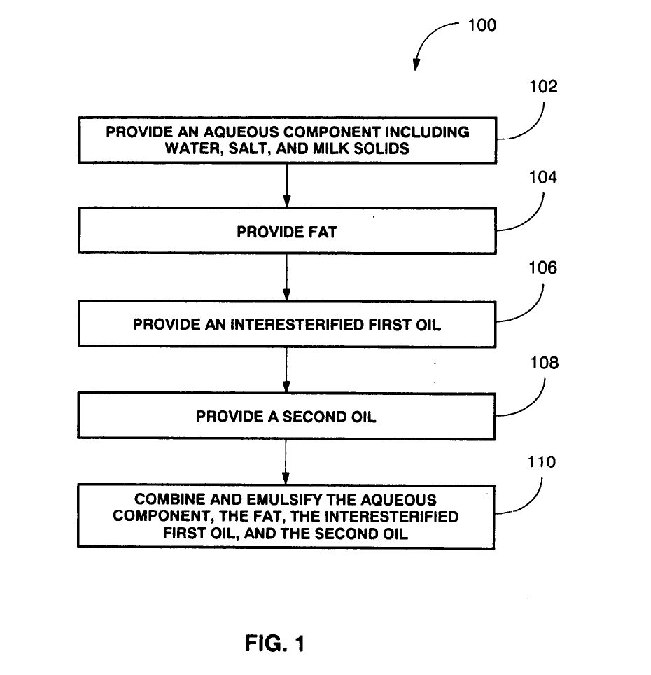

Referring generally to FIG. 1, a method 100 for producing a margarine product is shown. In a current embodiment, the method 100 includes the steps of providing aqueous component, ex. water 102, providing fat 104, and providing an interesterified first oil 106, providing a second oil 108. The method 100 further includes combining the aqueous component, the fat, and the interesterified first oil with a second oil into an emulsification 110.

In the present embodiment the method 100 further includes adding milk solids, salt, and preservatives into the emulsification. The margarine product produced via the above described combination is suitable for baking.

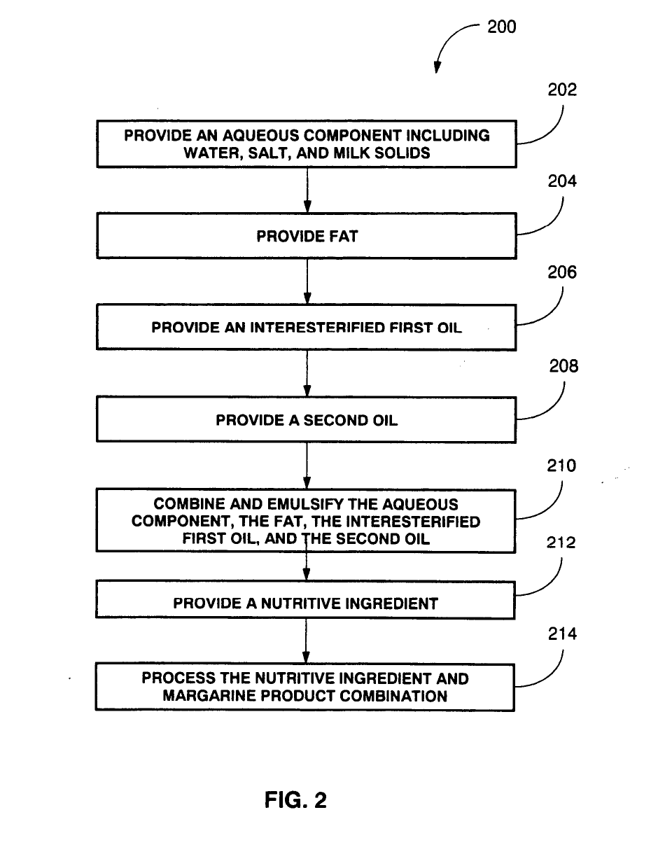

Referring generally to FIG. 2, a method 200 for producing a food product is shown. In a current embodiment, the method 200 includes the steps of providing aqueous component 202, providing fat 204, providing an interesterified first oil 206.. The method further includes combining the aqueous component, the fat, and the interesterified first oil with a second oil 208 into an emulsification 210. Additionally, the method includes providing a nutritive ingredient 212. The method further includes processing the nutritive ingredient and margarine product combination 214, for example via baking, cooking, freezing, refrigeration, sautéing, broiling, or frying.

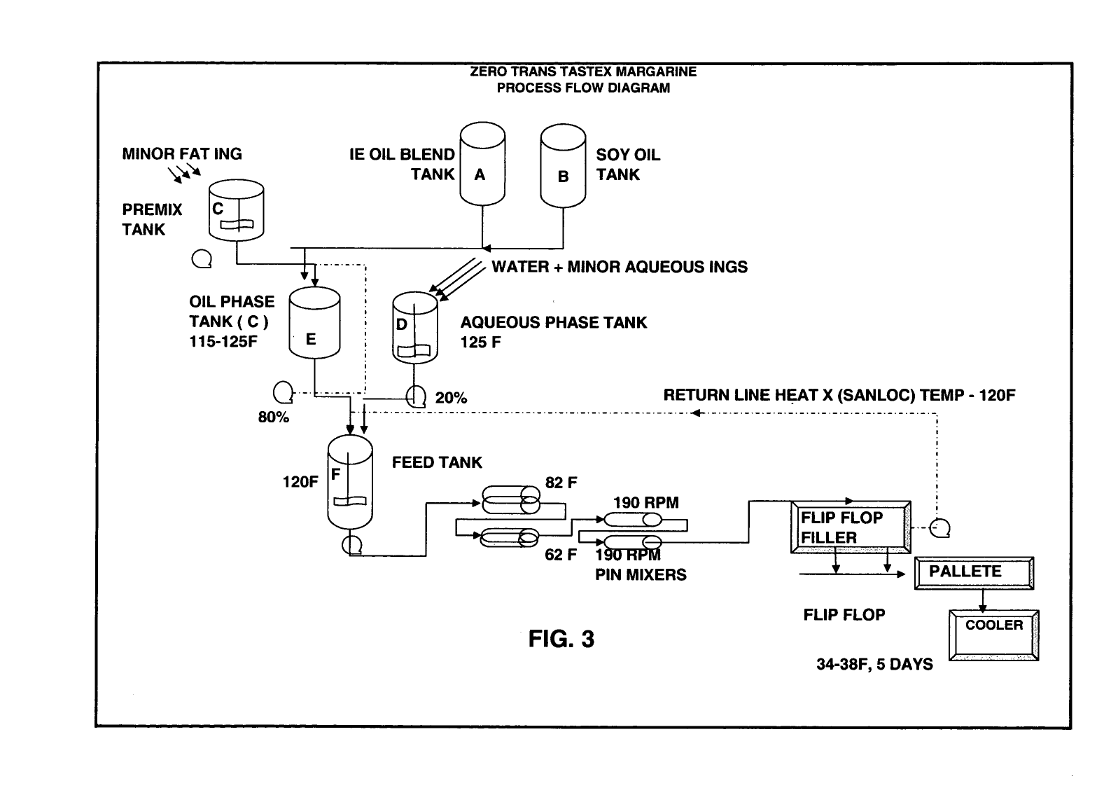

Referring generally to FIG. 3, a flow diagram demonstrating the margarine product process.

What is claimed is:

1. A margarine product, comprising:
Aqueous component, in a proportion of at the most 20% by weight of the margarine product, the aqueous component being emulsified in a fat;
A first oil; and a second oil, wherein the first oil is interesterified and blended with the second oil to allow the margarine product to be suitable for baking, the margarine product having a solid fat index range of 28±5 @ 50° F., 20±5 @ 70° F., 13±4 @ 80° F., 4±2 @ 92° F,. and 3 max @ 102° F. as defined by analytical method reference AOCS Cd 10-57.

2. The margarine product as claimed in claim 1, wherein the first oil includes at least one of palm oil and palm kernel oil.

3. The margarine product as claimed in claim 1, wherein the second oil includes at least one of liquid Soybean, Canola, Corn, Cottonseed or Sunflower Oil.

4. The margarine product as claimed in claim 1, further comprising:
a milk solid in a proportion of between about 0.6% and about 1.0% by weight of the margarine product.

5. The margarine product as claimed in claim 1, further comprising:
salt in a proportion of between about 1.0% and about 4.0% by weight of the margarine product.

6. The margarine product as claimed in claim 1, wherein the solid fat index is selected for functionality, including machine-ability, taste, texture, and baking characteristics of the dough using the above margarine.

7. The margarine product as claimed in claim 6, wherein the functionality, machine-ability, taste, texture, and baking characteristics resemble a conventional margarine product having trans fat levels of between 30% and 50%.

8. The margarine product as claimed in claim 1, wherein the fat is approximately 80% by weight of the product.

9. The margarine product as claimed in claim 1, wherein saturated fat is approximately 45% by weight of the product.

10. The margarine product as claimed in claim 1, wherein mono-unsaturated fat is approximately 15% by weight of the product.

11. The margarine product as claimed in claim 1, wherein poly-unsaturated fat is approximately 17% by weight of the product.

12. The margarine product as claimed in claim 1, wherein trans fat is less than 3% by weight of the product.

13. A food product, comprising:
a nutritive ingredient; and
a margarine product including aqueous component, fat in a proportion of 20:80 by weight of the margarine product, a first oil, and a second oil,
wherein the first oil is interesterified and blended with the second oil to provide a food product suitable for baking with a solid fat index of 28±5 @ 50° F., 20±5 @ 70° F., 13±4 @ 80° F., 4±2 @ 92° F., and 3 max @ 102° F. defined by analytical method reference AOCS Cd 10-57.

14. A food product as in claim 13, wherein the first oil includes at least one of palm oil and palm kernel oil.

15. A food product as in claim 13, wherein, the second oil includes at least one of liquid Soybean, Canola, Corn, Cottonseed or Sunflower Oil.

16. A food product as claimed in claim 13, further comprising:
a milk solid in a proportion of between about 0.6% and about 1.0% by weight of the margarine product.

17. A food product as claimed in claim 13, further comprising:
salt in a proportion of between about 2.8% and about 3.2% by weight of the margarine product.

18. The margarine product as claimed in claim 13, wherein the solid fat index is selected for functionality, including taste, texture, and baking characteristics.

19. A food product as claimed in claim 18, wherein the functionality, taste, texture, and baking characteristics resemble a conventional margarine product having trans fat levels of between 30% and 50%.

20. A food product as claimed in claim 13, wherein the fat is approximately 80% by weight of the product.

21. A food product as claimed in claim 13, wherein saturated fat is approximately 45% by weight of the product.

22. A food product as claimed in claim 13, wherein mono-unsaturated fat is approximately 15% by weight of the product.

23. A food product as claimed in claim 13, wherein poly-unsaturated fat is approximately 17% by weight of the product.

24. A food product as claimed in claim 13, wherein trans fat is less than 3% by weight of the product.

25. A method for producing a margarine product, comprising:
providing aqueous component;
providing fat;
providing an interesterified first oil; and
combining the aqueous component, the fat, and the interesterified first oil with a second oil into an emulsification;
wherein the combination produces the margarine product to be suitable for baking, the margarine product having a solid fat index of 28±5 @ 50° F., 20±5 @ 70° F., 13±4 @ 80° F., 4±2 @ 92° F., and 3 max @ 102° F. defined by analytical method reference AOCS Cd 10-57.

26. A method as claimed in claim 25, wherein the first oil includes at least one of palm oil and palm kernel oil.

27. A method as claimed in claim 25, wherein the second oil includes at least one of liquid soybean, canola, corn, cottonseed or sunflower oil.

28. A method as claimed in claim 25, wherein the margarine product includes salt in a proportion of between about 1% and about 4% by weight of the margarine product.

29. A method as claimed in claim 25, wherein the solid fat index is selected for functionality, including taste, texture, and baking characteristics.

30. A method as claimed in claim 29, wherein the functionality, taste, texture, and baking characteristics resemble a conventional margarine product having trans fat levels of between 30% and 50%.

31. A method as claimed in claim 25, wherein the fat is approximately 80% by weight of the product.

32. A method as claimed in claim 25, wherein saturated fat is approximately 45% by weight of the product.

33. A method as claimed in claim 25, wherein mono-unsaturated fat is approximately 15% by weight of the product.

34. A method as claimed in claim 25, wherein poly-unsaturated fat is approximately 17% by weight of the product.

35. A method as claimed in claim 25, wherein trans fat is less than 3% by weight of the product.

36. A method for producing a food product, comprising:
providing a nutritive product;
providing a margarine product having a emulsified first oil and a second oil, the margarine product having a solid fat index selected for baking, with a solid fat index of 28±5 @ 50° F., 20±5 @ 70° F., 13±4 @ 80° F., 4±2 @ 92° F., and 3 max @ 102° F., (analytical method reference AOCS Cd 10-57).
combining the nutritive product and the margarine product;
processing the combined nutritive product and margarine product; and
wherein the processing includes at least one of baking, cooking, freezing, refrigeration, sautéing, frying, broiling, or frying.

37. A method as claimed in claim 36, wherein the first oil includes at least one of palm oil and palm kernel oil.

38. A method as claimed in claim 36, wherein the second oil includes at least one of liquid soybean, canola, corn, cottonseed or sunflower oil liquid soybean oil.

39. A method as claimed in claim 36, further comprising; salt in a proportion of between about 2.8% and about 3.2% by weight of the margarine product.

40. A method as claimed in claim 36, wherein the solid fat index is selected for functionality, including taste, texture, and baking characteristics.

41. A method as claimed in claim 40, wherein the functionality, taste, texture, and baking characteristics resemble a conventional margarine product having trans fat levels of between 30% and 50%.

42. A method as claimed in claim 36, wherein the total fat is approximately 80% by weight of the margarine product.

43. A method as claimed in claim 36, wherein the saturated fat is approximately 45% by weight of the margarine product.

44. A method as claimed in claim 36, wherein the mono-unsaturated fat is approximately 15% by weight of the margarine product.

45. A method as claimed in claim 36, wherein the poly-unsaturated fat is approximately 17% by weight of the margarine product.

46. A method as claimed in claim 36, wherein the trans fat is less than 3% by weight of the margarine product.
